(19) United States
(12) Patent Application Publication
(10) Pub. No.: US 2026/0043427 A1
(43) Pub. Date: Feb. 12, 2026

(54) SHAFT-HUB CONNECTION HAVING A SHAFT WITH A FEATHER KEY GROOVE, A HOLLOW SHAFT, AND A FEATHER KEY, AND METHOD FOR PRODUCING A SHAFT-HUB CONNECTION

(71) Applicant: SEW-EURODRIVE GMBH & CO. KG, Bruchsal (DE)

(72) Inventors: Harald HUBER, Forst (DE); Julian KRATZ, Kraichtal (DE); Vanessa KEBERNIK, Mutterstadt (DE); Simon BOGNER, Eggenstein-Leopoldshafen (DE)

(73) Assignee: SEW-EURODRIVE GMBH & CO. KG, Bruchsal (DE)

(21) Appl. No.: 19/099,055

(22) PCT Filed: Jul. 4, 2023
(86) PCT No.: PCT/EP2023/068427

§ 371 Date: Jan. 28, 2025

(30) Foreign Application Priority Data
Aug. 3, 2022 (DE) 102022002810.7

(51) Int. Cl. F16B 7/18; F16D 1/112

(52) U.S. Cl. CPC F16B 7/18; F16D 1/112; F16D 2200/0021; F16D 2200/0056; F16D 2250/0084; F16D 2300/08

(57) ABSTRACT

A shaft-hub connection includes a shaft with a feather key groove, a hollow shaft, and a feather key. The hollow shaft has an inner groove, and the feather key is plugged into the feather key groove and radially protrudes into the inner groove of the hollow shaft. The feather key groove is only partially filled by the feather key, and a sealing part is received in the feather key groove.

### FIELD OF THE INVENTION

The present invention relates to a shaft-hub connection having a shaft with a feather key groove, a hollow shaft, and a feather key, and to a method for producing a shaft-hub connection.

### BACKGROUND INFORMATION

In certain conventional systems, in a shaft-hub connection, a shaft can be connected to a hollow shaft in a form-fitting manner in the circumferential direction, for example, via a feather key connection. For example, a shaft-hub connection is described in Japanese Patent Document No. 5-209607.

A locking pin for a clutch is described in U.S. Patent Application Publication No. 2007/0228728.

### SUMMARY

Example embodiments of the present invention increase the service life of a shaft-hub connection.

According to example embodiments, a shaft-hub connection includes a shaft with a feather key groove, a hollow shaft, and a feather key, and the hollow shaft has an inner groove. The feather key is plugged into the feather key groove and radially protrudes into the inner groove of the hollow shaft, the feather key groove is only partially filled by the feather key, and a sealing part is received in the feather key groove. For example, the sealing part fills, e.g., at least partially fills, the spatial region not filled by the feather key in the feather key groove.

Thus, splash water cannot penetrate into the feather key groove during cleaning because the sealing part seals the feather key groove from the environment in that the sealing part is arranged between the shaft and the hollow shaft. For example, the sealing part is at least partially plugged into the feather key groove, e.g., with a holding region, and a base region protrudes radially from the shaft into the inner groove of the hollow shaft, so that the sealing part seals the inner groove projecting in the axial direction towards the shaft. For this purpose, the sealing part has projecting lamellae, e.g., seal lips, on its base part, which respectively contact the shaft and the hollow shaft. The penetration of water into the circumferential angular region not covered by the sealing part is prevented by the shaft being pressed into the hollow shaft with a sufficiently tight fit, e.g., a press fit, is connected. There is thus no significant annular gap between the shaft and the hollow shaft. The sealing part closes the free space created by the inner groove of the hollow shaft, which free space opens into the external environment. The feather key groove is thus protected against the penetration of splash water.

According to example embodiments, the sealing part has a base region and a holding region, and the holding region is received in the feather key groove and/or is adjacent to the feather key. For example, the sealing part with its base region and holding region is arranged in one piece and/or in one part. Thus, the holding region plugged into the feather key groove holds the sealing part and the base region takes over the sealing function with its lamellae.

According to example embodiments, the base region protrudes in the axial direction beyond the region covered by the holding region in the axial direction. Thus, the splash water is kept axially far enough away from the feather key groove.

According to example embodiments, lamellae are formed on the base part, e.g., on the section of the base part that protrudes the region covered by the holding region in the axial direction, which seal from the base part towards the hollow shaft, e.g., towards the inner groove of the hollow shaft, and towards the shaft. Thus, the sealing is arranged on the sealing part, spatially separated from the holding function.

According to example embodiments, the lamellae are spaced apart from one another in the axial direction, e.g., regularly spaced apart from one another. Thus, if one of the lamellae fails, other lamellae are still available and thus a high level of protection against leaks can be achieved.

According to example embodiments, each of the lamellae extends around the outer circumference of the base region completely uninterrupted. Thus, sealing is ensured.

According to example embodiments, the base region is concavely curved on its side facing the shaft, and the radius of curvature is equal to the radius of the radial outer circumference of the shaft, e.g., in the region covered by the base part in the axial direction. Thus, the base region and the lamellae formed on it follow the outer shape of the shaft, and thus improved tightness can be achieved.

The lamellae can also be referred to as seal lips.

According to example embodiments, the holding region is formed semi-cylindrically. Thus, the feather key groove is filled by the feather key together with the sealing part.

According to example embodiments, the base region is substantially cuboidal. Thus, the inner groove of the hollow shaft can be arranged with a rectangular cross section and thus a sufficiently good filling of the inner groove can be achieved via the base region, and thus tightness can be ensured.

According to example embodiments, the wall thickness, e.g., the wall thickness measured in the axial direction, decreases monotonically, e.g., strictly monotonically, with increasing distance from the base region. Thus, the outermost tip of the respective lamella is readily deformed since the wall thickness is the lowest there. This allows an improved fit of the respective lamellae to the inner groove of the hollow shaft, and thus a high level of tightness can be ensured.

According to example embodiments, a screw is screwed into a centric threaded bore of the shaft, and the screw head of the screw rests against a retaining ring arranged axially in a form-fitting manner in an annular groove of the hollow shaft or against a shaft step of the hollow shaft. Thus, an axial limitation can be achieved readily and cost-effectively.

According to example embodiments, the inner groove of the hollow shaft extends around the shaft axially or extends at least from one end face to the region covered by the feather key groove in the axial direction, and, for example, includes this region. Thus, ready production is possible and the sealing part is not fixed in the axial direction.

According to example embodiments, each lamella has the shape of a rectangular frame or ring, e.g., with a trapezoidal cross-section. Thus, the lamella follows the shape of the inner groove, and thus tightness can be safely ensured. The lamellae respectively protrude radially at each circumferential angle position.

According to example embodiments, the base region, the holding region, and the lamellae are arranged as one piece and/or in one part. Thus, the sealing part can be produced readily and cost-effectively as an injection-molded plastic part and thus even a complex geometry does not increase production costs.

According to example embodiments, in a method for producing a shaft-hub connection, a sealing part is severed from a plastic injection-molded part and then plugged into a feather key groove. For example, the plastic injection-molded part includes further sealing parts, e.g., of sizes differing from the size of the sealing part.

Thus, different sizes of the shaft-hub connection with correspondingly different sized sealing parts can be produced cost-effectively, e.g., also with small batch sizes or even single-unit production. This is because the differently sized sealing parts can be produced together as one plastic injection-molded part, from which the required sealing part can be severed as required. For example, these sealing parts are arranged on a connecting web.

Further features and aspects of example embodiments of the present invention are explained in more detail below with reference to the appended schematic Figures.

### BRIEF DESCRIPTION OF THE DRAWINGS

FIG. 1 is a perspective view of a shaft-hub connection.

FIG. 2 is a cross-sectional view of the shaft-hub connection.

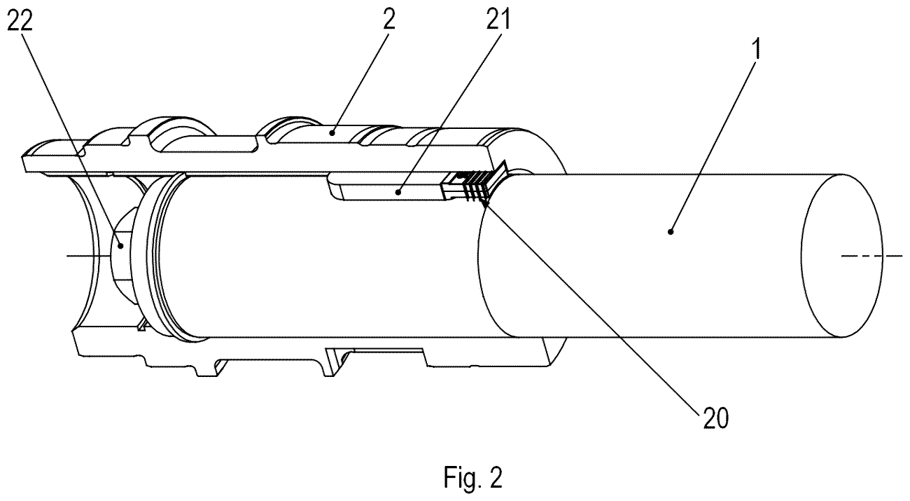

FIG. 3 is an exploded perspective view of the shaft-hub connection.

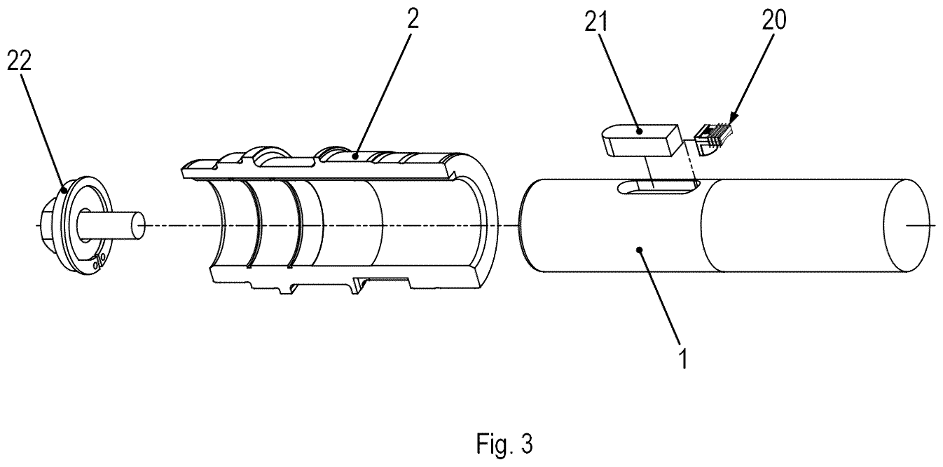

FIG. 4 is a perspective view of a sealing part 20 of the shaft-hub connection.

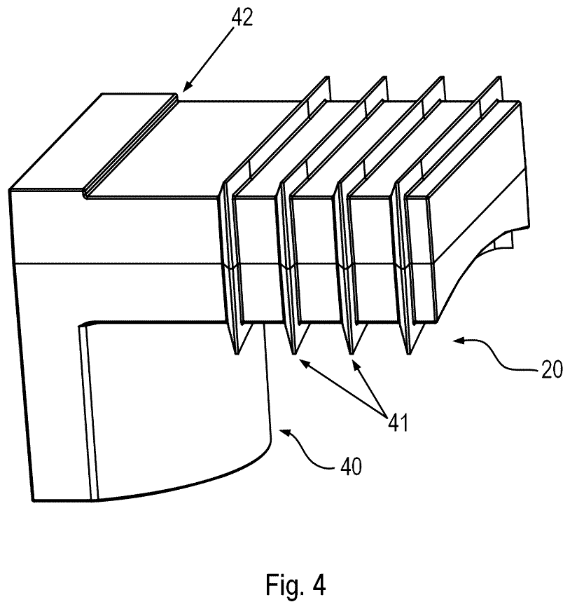

FIG. 5 is a perspective view of an injection-molded part 50.

### DETAILED DESCRIPTION

As illustrated in the Figures, the shaft-hub connection has a shaft 1 with a feather key groove. A feather key 21 is plugged into the feather key groove of the shaft 1 and radially protrudes into an inner groove, e.g., an axial groove, e.g., another feather key groove, of a hollow shaft 2 of the shaft-hub connection.

The feather key groove has two semi-cylindrical rounded regions, between which a cuboid region is formed.

The feather key 21 does not completely fill the feather key groove of the shaft 1 but only has one of the semi-cylindrically rounded regions and the cuboid region.

Thus, one of the two semi-cylindrically rounded regions remains free even after the feather key 21 has been plugged in.

To close this free spatial region, a sealing part 20 is plugged into this spatial region.

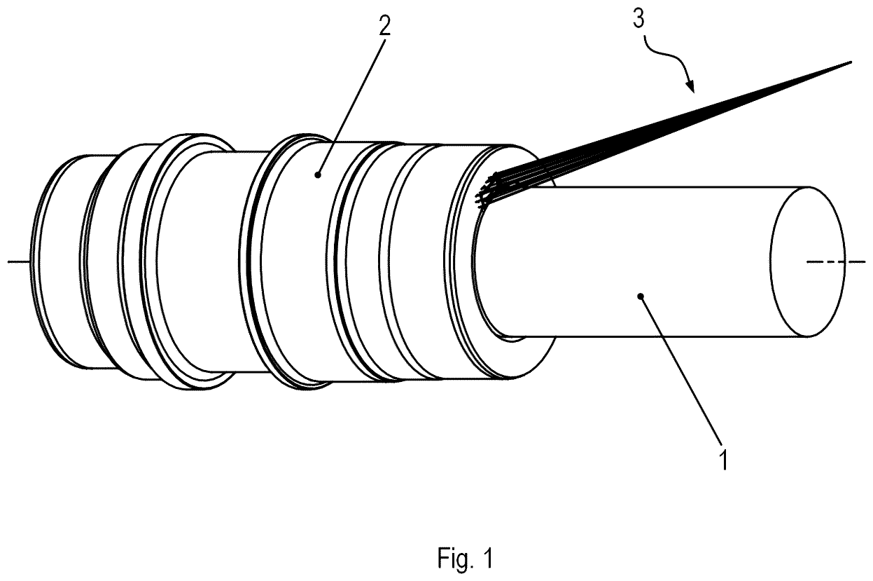

As illustrated in FIG. 1, the sealing part 20 prevents a jet of water 3 from penetrating into the feather key groove during cleaning.

The shaft 1 and the hollow shaft 2 are each formed or consist of metal, e.g., steel.

The sealing part 20 is, for example, made of plastic, e.g., of an elastomer.

The sealing part 20 protrudes radially from the feather key groove of the shaft 1 into the inner groove of the hollow shaft 2 and thus seals towards the hollow shaft 2.

The sealing part has a semi-cylindrical rounded region, which fills the spatial region remaining free after plugging the feather key 21 into the feather key groove of the shaft 1. Furthermore, the sealing part 20 has a substantially cuboid region which adjoins the semi-cylindrical rounding region and is located radially outside the feather key groove of the shaft 2 and thus protrudes into the inner groove of the hollow shaft 2.

The cuboid region of the sealing part 20 protrudes axially beyond the semi-cylindrical round region and protrudes into the inner groove of the hollow shaft 2.

On its side facing the shaft 1, the cuboid region is concavely curved, and the amount of the radius of curvature is equal to the radius of curvature of the radial outer circumference of the shaft 1 in the region covered by the cuboid region of the sealing part 20 in the axial direction.

For example, the internal groove extends axially through the hollow shaft 1 completely or at least from one end face of the hollow shaft 2 up to and over the region covered by the feather key groove in the axial direction.

Lamellae 41 are formed on the cuboid region of the sealing part 20, which respectively extend around the cuboid region of the sealing part 20 completely in a radial direction. For example, the lamellae 41 protrude in all circumferential angle positions in the radial direction on the transverse region of the sealing part 20.

Each lamella has the shape of a rectangular frame or ring.

In the axial direction, the lamellae 41 are spaced apart from one another, e.g., evenly.

For example, between two and six lamellae 41 are formed, e.g., four lamellae 41 are formed. Each of the lamellae 41 has a wall thickness, e.g., a wall thickness measured in the axial direction, which decreases monotonically, e.g., strictly monotonically, with increasing distance from the cuboid region of the sealing part 20. Via the lamellae 41, e.g., thus the sealing lamellae, the sealing part 20 seals both towards the hollow shaft 2 and towards the shaft 1.

Thus, water from a water jet 3 is prevented from penetrating into the feather key groove.

The axial direction is aligned parallel to the axis of rotation of the shaft 1. The axis of rotation of the hollow shaft 2 is oriented coaxially to the axis of rotation of the shaft 1.

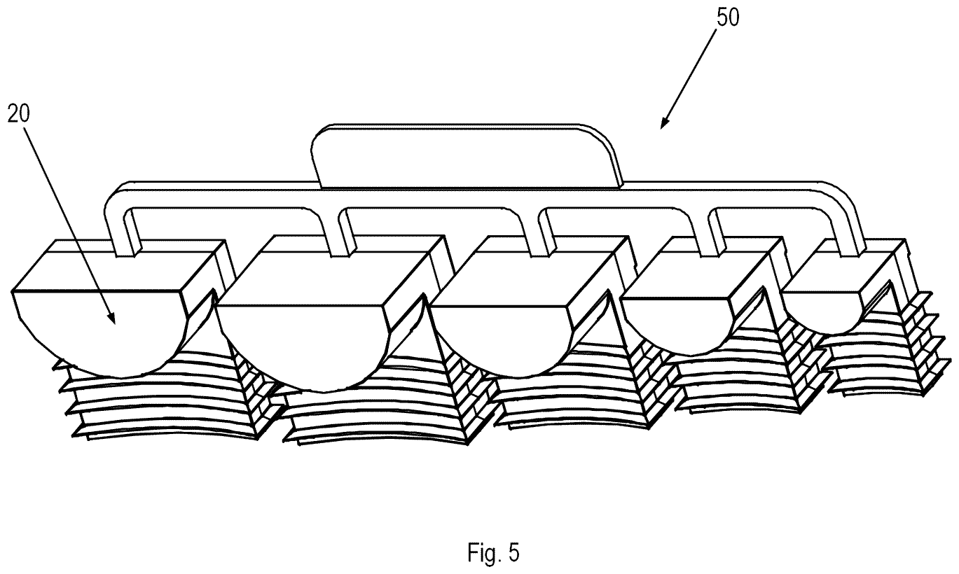

As illustrated in FIG. 5, the sealing part 20 is produced from a plastic injection-molded part 50, on which not only the sealing part 20 but also corresponding sealing parts of different sizes are formed together.

Thus, the sealing part 20 and the other sealing parts include the plastic injection-molded part, e.g., they are arranged in one piece, i.e., in one part, on the plastic injection-molded part. The sealing parts can be readily severed from the plastic injection-molded part 50 at a predetermined breaking point having a thinned configuration.

An elastomer, e.g., rubber, is suitable as the material of the sealing part 20.

For example, the feather key is configured without semi-cylindrical rounded regions, e.g., so that the feather key is arranged as a cuboid body.

### LIST OF REFERENCE NUMERALS

1 Shaft
2 Hollow shaft
3 Water jet
20 Sealing part
21 Feather key
22 Screw
40 Semi-cylindrical section
41 Lamellae
42 Step
50 Injection-molded part

1-15. (canceled)

16. A shaft-hub connection, comprising:
a shaft including a feather key groove;
a hollow shaft including an inner groove;
a feather key arranged in the feather key groove, only partially filling the feather key groove, and radially protruding into the inner groove of the hollow shaft; and
a seal arranged in the feather key groove.

17. The shaft-hub connection according to claim 16, wherein the seal at least partially fills a spatial region of the feather key groove not filled by the feather key.

18. The shaft-hub connection according to claim 16, wherein the seal fills a spatial region of the feather key groove not filled by the feather key.

19. The shaft-hub connection according to claim 16, wherein the seal has a base region and a holding region, the holding region being arranged in the feather key groove and/or adjacent to the feather key.

20. The shaft-hub connection according to claim 19, wherein the seal is arranged as an integral component.

21. The shaft-hub connection according to claim 19, wherein the base region protrudes in an axial direction beyond a region covered by the holding region in the axial direction.

22. The shaft-hub connection according to claim 19, wherein the base region includes lamellae that seal from the base region toward the hollow shaft and toward the shaft.

23. The shaft-hub connection according to claim 22, wherein the lamellae are arranged on a section of the base region that protrudes beyond the region covered by the holding region in the axial direction and seal from the base region toward the inner groove of the hollow shaft.

24. The shaft-hub connection according to claim 22, wherein the lamellae are spaced apart from one another in the axial direction.

25. The shaft-hub connection according to claim 22, wherein the lamellae are regularly spaced apart from one another in the axial direction.

26. The shaft-hub connection according to claim 22, wherein each of the lamellae extends around an outer circumference of the base region completely uninterrupted.

27. The shaft-hub connection according to claim 19, wherein a side of the base region facing the shaft is concavely curved having a radius of curvature equal to a radius of a radial outer circumference of the shaft, in particular in the region covered by the base part in the axial direction.

28. The shaft-hub connection according to claim 19, wherein a side of the base region facing the shaft is concavely curved having a radius of curvature equal to a radius of a radial outer circumference of the shaft in a region covered by the base region in the axial direction.

29. The shaft-hub connection according to claim 19, wherein the holding region is semi-cylindrical.

30. The shaft-hub connection according to claim 19, wherein the base region is substantially cuboidal.

31. The shaft-hub connection according to claim 19, wherein the base region is cuboidal.

32. The shaft-hub connection according to claim 22, wherein a wall thickness of the lamellae and/or a wall thickness of the lamellae measured in the axial direction decreases monotonically and/or strictly monotonically with increasing distance from the base region.

33. The shaft-hub connection according to claim 16, further comprising a screw arranged a centric threaded bore of the shaft, a screw head of the screw resting against a retaining ring arranged axially in a form-fitting manner in an annular groove of the hollow shaft and/or against a shaft step of the hollow shaft.

34. The shaft-hub connection according to claim 16, wherein the inner groove of the hollow shaft extends around the shaft axially and/or extends at least from one end face to a region covered by the feather key groove in the axial direction.

35. The shaft-hub connection according to claim 22, wherein each lamella is shaped as a rectangular frame or a ring and/or has a trapezoidal cross-section.

36. The shaft-hub connection according to claim 22, wherein the base region, the holding region, and the lamellae are integral.

37. A method of producing a shaft-hub connection as recited in claim 16, comprising:
severing the seal from a a plastic injection-molded part; and
after the severing, inserting the seal into the feather key groove.

38. The method according to claim 37, wherein the plastic injection-molded part includes a plurality of different sized seals.
